(19) United States
(12) Patent Application Publication
(10) Pub. No.: US 2020/0291973 A1
(43) Pub. Date: Sep. 17, 2020

(54) CLAMP

(71) Applicant: AUTO-TROL LIMITED, ALOHA, OR (US)

(72) Inventors: LEE V. GASSAWAY, Aloha, OR (US); BRANDON M. ORTH, Aloha, OR (US)

(73) Assignee: AUTO-TROL LIMITED, ALOHA, OR (US)

(21) Appl. No.: 16/813,059

(22) Filed: Mar. 9, 2020

Related U.S. Application Data
(60) Provisional application No. 62/818,076, filed on Mar. 13, 2019.

(51) Int. Cl. F16B 2/10; F16B 1/00; H01R 4/40; H01R 4/42

(52) U.S. Cl. CPC F16B 2/10; F16B 1/00; F16B 2001/0064; H01R 4/42; H01R 4/40

(57) ABSTRACT

A clamp comprises first and second jaws with an elongate threaded member allowing threaded movement of one jaw along the member by rotation of the elongate member while allowing movement of the other jaw without regard to the threads. Clamp teeth, which may have a surface profile designed to conform to the clamped article, may be provided

### CROSS-REFERENCE TO RELATED APPLICATIONS

This application claims the benefit of U.S. provisional patent application Ser. No. 62/818,076, filed Mar. 13, 2019, entitled CLAMP, to disclosure of which is incorporated herein by reference.

### BACKGROUND

This disclosure relates to clamps, and more particularly to an adjustable clamp for attaching to a variety of objects.

It is often desired to mount objects to existing structures by use of clamps. For example, equipment or markers might be attached to power lines, such as monitoring equipment, markers to highlight the presence of the power lines, bird diverters to help prevent bird impacts with power lines.

### SUMMARY

In accordance with the disclosure, an adjustable clamp mechanism is provided.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a perspective view of a clamp according to an embodiment of the disclosure;

FIG. 2 is a view of a clamp according to an embodiment of the disclosure in a fully open position;

FIG. 3 is a view of a clamp according to an embodiment of the disclosure in a fully closed position;

FIG. 4 is a side view of a clamp according to an embodiment of the disclosure;

FIG. 5 is a top view of a clamp according to an embodiment of the disclosure;

FIG. 6 is an end view of a clamp according to an embodiment of the disclosure; and

FIG. 7 is an exploded view of a clamp according to an embodiment of the disclosure.

### DETAILED DESCRIPTION

The system according to a preferred embodiment of the present disclosure comprises and adjustable clamp that can be tightened or loosened to provide the desired clamping force, while providing a mounting support for attaching items to structures.

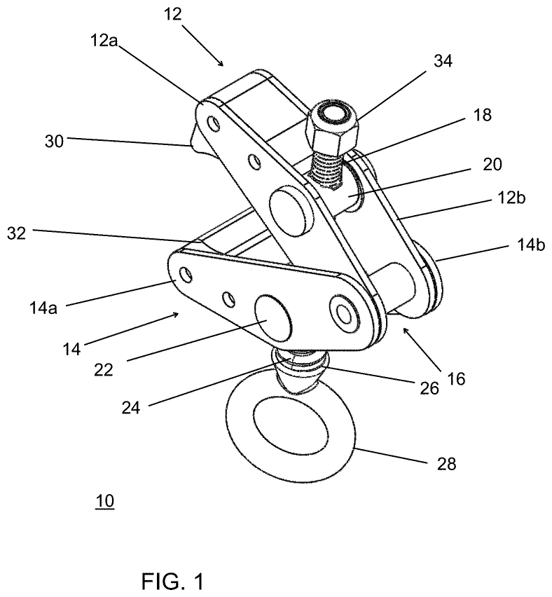

Referring to FIG. 1, a perspective view of a clamp 10, the clamp comprises upper and lower jaw members 12, 14, which are defined by spaced brackets 12a, 12b and 14a, 14b. The jaw members hingedly connect via and operate about hinge member 16. An elongate threaded member 18 threadingly engages the upper jaw via threaded pin 20 that spans and defines the distance between jaw members 12a and 12b. A pin 22 with central through hole that is not threaded spans and defines the distance between jaw members 14a and 14b, and receives elongate threaded member 18 therethrough. A spring member 24 is positioned on threaded member 18, below pin 22, and seats against a shoulder 26 defined on the threaded member. Below shoulder 26, a mounting member 28, such as the illustrated eyebolt, may be provided for mounting items to the clamp. At the front end of the clamp jaws, at the end distal from the hinge member, an upper clamp tooth member 30 is provided at the upper jaw member 12, and a lower clamp jaw 32 is provided at the lower jaw member 14. A lock nut 34 is provided at the top of threaded member 18.

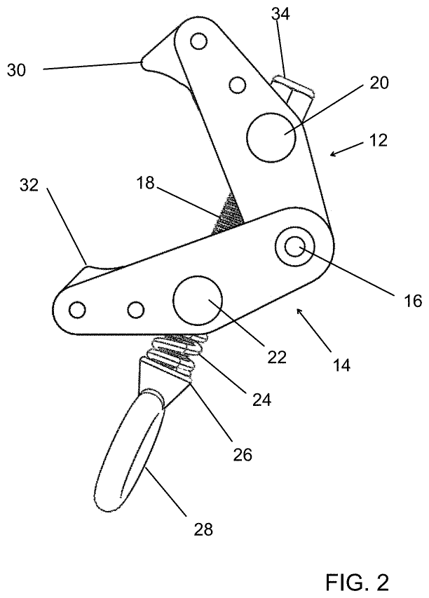

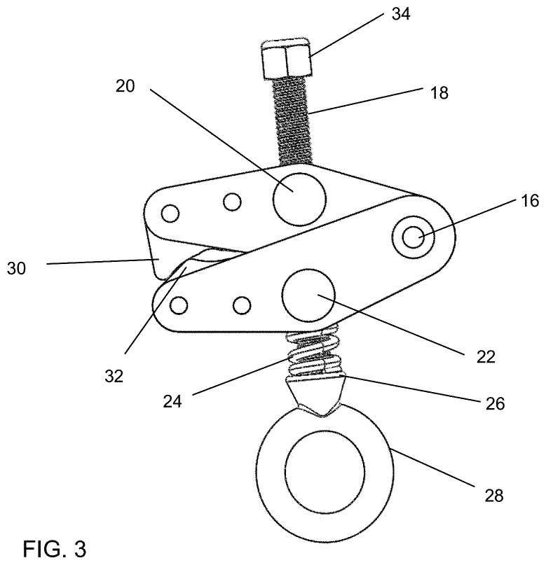

Referring now to FIGS. 2 and 3, views of the clamp in the fully open and fully closed positions, respectively, by rotation of the elongate member 18 in an appropriate direction based on the threads, the threaded engagement with threaded pin 20 causes the threaded pin to ride upwardly along the length of the elongate member, until the top surface of the pin 20 meets the bottom face of lock nut 34. The bottom jaw is free to remain in position, as biased toward the upper jaw by the presence of spring 24. On rotation of the elongate member in the opposite direction, the threaded pin 20 will move down the length of the elongate member, moving the upper jaw and lower jaw closer together, until as seen in FIG. 3, the upper clamp tooth member 30 and lower clamp jaw 32 engage. In the case of clamping to an article, such as a power line or other article, rotation from open to closed would continue until the desired clamping force has been attained for the particular use. The spring 24 keeps the clamp biased to a closed position. Lock nut 34 may be rotated to travel down the elongate member to contact the upper surface of threaded pin 20, to lock the clamp position.

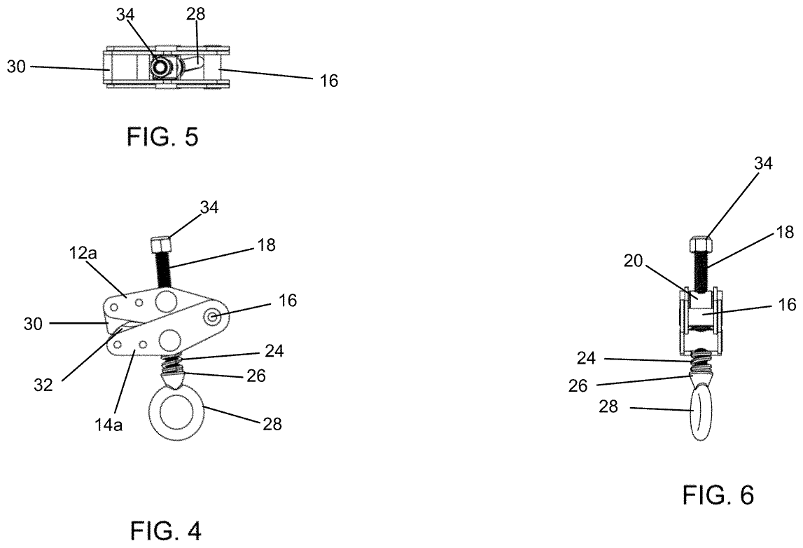

FIGS. 4-6 illustrate different angle views of the clamp, side view in FIG. 4 (the opposite side would typically be a mirror image of FIG. 4), a top view (FIG. 5) and a right end view (FIG. 6).

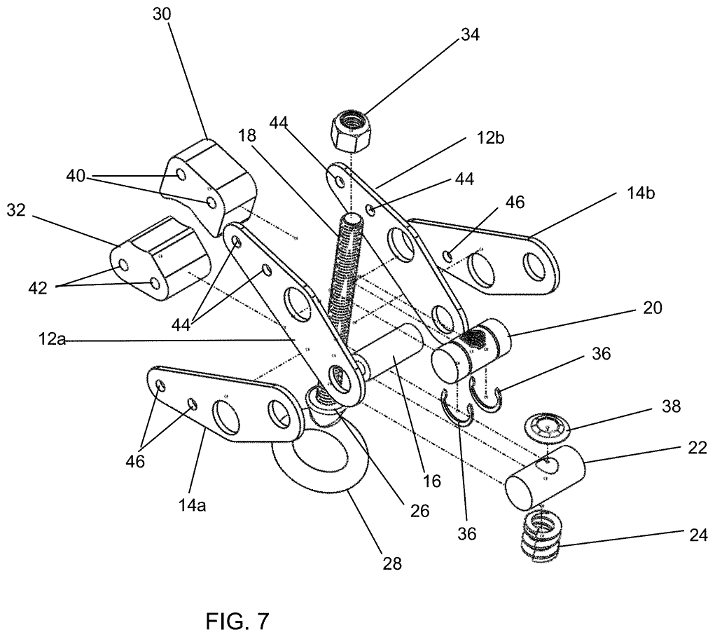

FIG. 7 is an exploded view of the clamp to provide a better understanding of the configuration of the clamp. Additional items visible in FIG. 7 that were hidden in the other views include left and right retaining rings 36 which maintain the threaded pin in position, and push ring 38, which assists in transferring the push of the threaded pin to the through hole pin to accomplish clamping force. The upper clamp tooth member 30 and lower clamp jaw 32 suitably have through mounting holes 40, 42 which mount the tooth member and jaw to the upper and lower jaw members via mounting holes 44, 46 in the jaws via any suitable means, such as pins or threaded fasteners, for example. The inner faces of the clamp teeth and clamp jaw may have a surface profile, such as an elongate curved surface visible on the lower clamp jaw, so that the jaws conform to a surface profile of the clamped item. For example, if a power line or cable is to be clamped, the curved surface illustrated in FIG. 7 can ensure greater contact area between the clamp teeth/jaw and the clamped surface. Other profiles may be used depending on the particular use environment of the clamp.

Depending on the intended use, the clamp can be constructed to be conductive or non-conductive, for example being conductive when used to attach items to power lines that would draw power from the power lines, or non-conductive when insulation from the clamped surface is desired.

In power line uses of the particular illustrated embodiment, the clamp is designed to enable easy installation of an object on a broad range of energized power lines in a variety of cable sizes (e.g., ⅝″ to 2″). The clamps may be attached directly to the object via an adapter plate or bolts, or may be used as a standalone clamp. The clamps are designed for easy installation by a lineman using a hot stick (a specialized stick used by power company employees to work on energized power lines). Further, the clamps are designed for use in high-wind applications, because they can be adjusted in the field to firmly clamp to the line, minimizing the possibility of the object spinning in the wind once attached.

While the illustrated embodiment includes an eyebolt for easy operation with a hot stick in power line applications or for allowing items to be attached directly to the clamp, such as hanging items that hang from or attach to the eyebolt, the clamp may also be attached in other ways for other uses, such as securing the clamp directly to an object so that the object may then be clamped to a structure. In such case, the eyebolt portion can be alternatively replaced with another suitable mechanism for rotating the threaded member. This other mechanism may comprises a screw drive, for example, such as hex head, hex socket (Allen), Torx-style, slotted, phillips, to name a few. Thus the clamp can be used in a variety of situations to attach various objects to other items.

Accordingly, an improved clamp is shown and described.

While a preferred embodiment of the technology has been shown and described, it will be apparent to those skilled in the art that many changes and modifications may be made without departing from the broader aspects.

The appended claims are therefore intended to cover all such changes and modifications as fall within the true spirit and scope of the technology.

What is claimed is:

1. A clamp, comprising:
a first jaw hingedly attached with a second jaw; and
an adjustment member for opening or closing the first and second jaw relative to one another, wherein said adjustment member comprises:
an elongate threaded member threadingly engaging one of said first and second jaws and slidingly engaging the other of said first and second jaws.

2. The clamp according to claim 1, further comprising a biasing member for biasing said first and second jaws towards one another.

3. The clamp according to claim 1, wherein at least one of said first and second jaws has a tooth member mounted thereto for engaging with a clamped item.

4. The clamp according to claim 3, wherein said tooth member comprises an electrically conductive material.

5. The clamp according to claim 3, wherein said tooth member comprises an electrically insulative material.

6. The clamp according to claim 1, wherein said first jaw has a first tooth member mounted thereto for engaging with a clamped item and said second jaw has a second tooth member mounted thereto for engaging with the clamped item.

7. The clamp according to claim 6, wherein at least one of said first and second tooth members comprises an electrically conductive material.

8. The clamp according to claim 6, wherein at least one of said first and second tooth members comprises an electrically insulative material.

9. The clamp according to claim 1, further comprising a mounting member for mounting items to the clamp.

10. The clamp according to claim 9 wherein said mounting member comprises a loop member mounted to an end of said elongate threaded member.

11. The clamp according to claim 3 wherein said tooth member has a profile for engagement with a power line.

12. The clamp according to claim 6 wherein said first and second tooth members have profiles for engagement with a power line.

13. A method of providing a clamp, comprising:
providing a first jaw hingedly attached with a second jaw; and
providing an adjustment member for opening or closing the first and second jaw relative to one another, wherein said adjustment member comprises:
an elongate threaded member threadingly engaging one of said first and second jaws and slidingly engaging the other of said first and second jaws.

14. The method according to claim 13, further comprising providing a biasing member for biasing said first and second jaws towards one another.

15. The method according to claim 13, further comprising providing at least one of said first and second jaws with a tooth member mounted thereto for engaging with a clamped item.

16. The method according to claim 15, wherein said tooth member comprises an electrically conductive material.

17. The method according to claim 15, wherein said tooth member comprises an electrically insulative material.

18. The method according to claim 13, further comprising providing said first jaw with a first tooth member mounted thereto for engaging with a clamped item and providing said second jaw with a second tooth member mounted thereto for engaging with the clamped item.

19. The method according to claim 18, wherein at least one of said first and second tooth members comprises an electrically conductive material.

20. The method according to claim 18, wherein at least one of said first and second tooth members comprises an electrically insulative material.
